(19) United States
(12) Patent Application Publication
(10) Pub. No.: US 2026/0059621 A1
(43) Pub. Date: Feb. 26, 2026

(54) HEATING DEVICE FOR ACTIVATING PRESSURE-SENSITIVE ADHESIVE TAPE AND THERMOPLASTIC OR THERMOSETTING ADHESIVE TAPE

(71) Applicants: Singleton (Changzhou) Material Technology Co.Ltd, Changzhou (CN); Suzhou SIP Hi-TECH Precision Electronics Co.,Ltd, Suzhou (CN)

(72) Inventors: Yifang WANG, Changzhou (CN); Shengbao WANG, Changzhou (CN)

(73) Assignees: Singleton (Changzhou) Material Technology Co.Ltd, Changzhou (CN); Suzhou SIP Hi-TECH Precision Electronics Co.,Ltd, Suzhou (CN)

(21) Appl. No.: 18/953,160

(22) Filed: Nov. 20, 2024

(30) Foreign Application Priority Data
Aug. 20, 2024 (CN) 2024220199731
Sep. 14, 2024 (CN) 2024222665478

(51) Int. Cl. H05B 6/80; C09J 5/06; C09J 7/35; C09J 7/38

(52) U.S. Cl. CPC H05B 6/80; C09J 5/06; C09J 7/35; C09J 7/38

(57) ABSTRACT

A heating device for activating a pressure-sensitive adhesive tape and a thermoplastic or thermosetting adhesive tape includes a microwave heating head, a microwave emitting component, and a motion driving component. The microwave emitting component is connected to the microwave heating head, and used to output microwaves to the microwave heating head. The motion driving component is connected to the microwave heating head for achieving the alignment and motion of the microwave heating head and a heated component. The microwave heating head is driven by the motion driving component to heat the heated component. Through the cooperation of the microwave emitting component and the motion driving component, the flexible heating of the pressure-sensitive adhesive tape and the thermoplastic or thermosetting adhesive tape according to a set motion trajectory is achieved by deploying microwaves with appropriate power. A heating object is the pressure-sensitive adhesive tape and the thermoplastic or thermosetting adhesive tape.

### CROSS REFERENCE TO THE RELATED APPLICATIONS

This application is based upon and claims priority to Chinese Patent Application No. 202422019973.1, filed on Aug. 20, 2024, and Chinese Patent Application No. 202422266547.8, filed on Sep. 14, 2024, the entire contents of which are incorporated herein by reference.

### TECHNICAL FIELD

The present disclosure belongs to the technical field of heating pressure-sensitive adhesive tapes and thermoplastic or thermosetting adhesive tapes for activation, in particular to a heating device for rapidly activating a pressure-sensitive adhesive tape and a thermoplastic or thermosetting adhesive tape.

### BACKGROUND

With the rapid development of manufacturing industry, the design direction of consumer electronic components is developing towards small size, narrow frame, and high bonding strength. Therefore, the application of the hard pressure-sensitive adhesive tape with high cohesion and peeling force and the thermosetting adhesive tape in industry, automobile and electronics becomes more and more extensive. The hard pressure-sensitive adhesive tape with high cohesion and peeling force mainly refers to pressure-sensitive adhesive with modulus more than 50% higher than that of the conventional pressure-sensitive adhesive and stronger cohesion, and in general, the peeling force can reach more than 20 N/cm. However, there are some problems such as low initial viscosity and poor wettability. The thermoplastic adhesive tape mainly refers to thermoplastic elastomer adhesive films, mainly including adhesive films prepared from polar thermoplastic elastomers such as thermoplastic polyurethane, thermoplastic copolyester, thermoplastic polyamide and EVA (ethyl vinyl acetate). The thermosetting adhesive tape generally refers to adhesive tape materials with thermosetting properties, mainly including thermosetting epoxy, thermosetting polyurethane, thermosetting acrylate adhesive tape, or hybrid type thermosetting adhesive tapes, which can be bonded by heating and cured by heating to form the adhesive strength similar to the structural glue. In general, the shear strength of more than 5 MPa can be reached. Compared with liquid glue, the thermosetting adhesive film has the advantages of easy graphic die cutting, low glue overflow, convenient operation, and controllable thickness and uniformity. The minimum thickness can reach 5 um, and precise bonding assembly can be achieved.

In general, the assembly of the pressure-sensitive adhesive tape includes bonding by a pressing plate or roller at room temperature. For the hard pressure-sensitive adhesive with high cohesion, it is often necessary to increase the pressure or temperature at room temperature to speed up the wetting and bonding speed of such a pressure-sensitive adhesive. However, in the assembly of irregular or fragile component structures, the pressure is limited, so the wetting and bonding speed of the pressure-sensitive adhesive tape can only be improved by low pressure combined heating, and the production efficiency of the assembly line should be taken into consideration. Similarly, in the practical application of the thermoplastic adhesive film or thermosetting adhesive tape, the heating temperature for some precision components is required to be no higher than 75° C., while the initial reaction temperature of the ordinary thermosetting adhesive tape is generally higher than 75° C. Meanwhile, it is required that only the adhesive tape than other components can be heated, and rapid heating can be preferably achieved. Therefore, local rapid heating or low-temperature activation is also needed in the actual assembly process of the thermosetting adhesive tape.

Therefore, it is necessary to provide a heating device capable of achieving rapid heating or low-temperature activation of a pressure-sensitive adhesive tape or a thermosetting adhesive tape.

### SUMMARY

A main objective of the present disclosure is to provide a heating device capable of achieving flexible, rapid and uniform heating or low-temperature and rapid activation and curing of a pressure-sensitive adhesive tape and a thermoplastic or thermosetting adhesive tape, so as to overcome the shortcomings of the prior art.

To achieve the objective of the present disclosure, the technical solution adopted by the present disclosure includes a heating device for activating a pressure-sensitive adhesive tape and a thermoplastic or thermosetting adhesive tape.

The pressure-sensitive adhesive tape specifically includes an acrylic, rubber, polyurethane, silicone or hybrid single-sided pressure-sensitive adhesive tape, double-sided pressure-sensitive adhesive tape, or substrate-free pressure-sensitive adhesive tape.

The thermoplastic adhesive tape specifically includes an adhesive film prepared from a polar thermoplastic elastomer such as thermoplastic polyurethane, thermoplastic copolyester, thermoplastic polyimide, or EVA.

The thermosetting adhesive tape specifically includes an epoxy, polyurethane, acrylic or hybrid latent thermosetting single-sided adhesive tape, thermosetting double-sided adhesive tape, or thermosetting substrate-free adhesive tape.

The heating device includes:
a microwave heating head;
a microwave emitting component, connected to the microwave heating head, and used to output microwaves to the microwave heating head; and
a motion driving component, connected to the microwave heating head, and used to achieve alignment and motion of the microwave heating head and a heated component.

The microwave heating head is driven by the motion driving component to heat a heated component.

In a preferred embodiment, the microwave emitting component includes a microwave emitter for generating microwaves.

In a preferred embodiment, the microwave emitting component further includes a microwave variable-frequency amplifier, which is connected to the microwave emitter, and used to perform variable-frequency amplification on the microwaves generated by the microwave emitter.

In a preferred embodiment, the microwave emitting component further includes a coupler, which is connected to the microwave variable-frequency amplifier, and used for power distribution or screening of microwaves after variable-frequency amplification.

In a preferred embodiment, the microwave emitting component further includes a power meter, which is connected to the microwave variable-frequency amplifier, and used for real-time power detection of the microwaves after variable-frequency amplification.

In a preferred embodiment, the motion driving component includes a mechanical arm, and/or guide rail platform; the mechanical arm is connected to the microwave heating head, and used to drive the microwave heating head to heat the heated component according to a set motion trajectory; and meanwhile, the mechanical arm can provide a press-fitting force of 0.05-0.5 MPa to achieve a pressing function. The guide rail platform is connected to the heated component, and used to drive the heated component to move.

In a preferred embodiment, the heated component is positioned and fixed through a positioning mounting fixture arranged on the guide rail platform.

In a preferred embodiment, the microwave heating head is at least arranged to be hollow-square, square, circular, annular, or L-shaped.

In a preferred embodiment, the heating device further includes a controller, and the microwave emitting component and the motion driving component are both connected to the controller.

In a preferred embodiment, the heating device further includes a power supply for supplying power to the whole heating device, and the power supply is connected to the controller and the microwave emitting component.

In a preferred embodiment, the heating device further includes an optical coordinate sensor and/or a temperature detector arranged on the microwave heating head. The optical coordinate sensor and the temperature detector are used to respectively monitor position coordinates and the temperature of the microwave heating head in real time.

According to a heating device for rapidly activating a pressure-sensitive adhesive tape and a thermoplastic or thermosetting adhesive tape. The mechanism of action of heating the pressure-sensitive adhesive tape and the thermoplastic or thermosetting adhesive tape by the heating device is mainly that polar groups of the pressure-sensitive adhesive tape and the thermoplastic or thermosetting adhesive tape are heated by microwaves to generate molecular resonance and generate heat. The heating effect is carried out simultaneously inside and outside, and has uniform and rapid technical advantages compared with the conventional hot-pressing plate for heating with the heat conduction effect from outside to inside, and the room temperature can be increased to 70-80° C. within dozens of seconds. Meanwhile, the polar molecular resonance caused by microwaves can accelerate the molecular interaction between a latent curing agent and reactive groups in the thermosetting adhesive tape, thus reducing the initial reaction temperature.

Compared with the prior art, the present disclosure has beneficial effects as follows:
1. According to the cooperation of the microwave emitting component and the motion driving component of the present disclosure, the flexible heating of the pressure-sensitive adhesive tape and the thermoplastic or thermosetting adhesive tape according to the set motion trajectory can be achieved by deploying the microwaves with appropriate power.
2. The flexible heating of various irregular pressure-sensitive adhesive tapes and thermoplastic or thermosetting adhesive tapes can be achieved by arranging the microwave heating head to be structured in various patterns.

### BRIEF DESCRIPTION OF THE DRAWINGS

To describe the technical solutions of the present disclosure or in the prior art more clearly, the following briefly introduces the accompanying drawings required for describing the embodiments or the prior art. Apparently, the accompanying drawings in the following description show merely some embodiments of the present disclosure, and those of ordinary skill in the art may still derive other drawings from these accompanying drawings without creative efforts.

FIG. 1 is a schematic block diagram of a heating device for rapidly activating a pressure-sensitive adhesive tape and a thermoplastic or thermosetting adhesive tape according to a specific embodiment of the present disclosure;

FIG. 2 is a schematic block diagram of a heating device for rapidly activating a pressure-sensitive adhesive tape and a thermoplastic or thermosetting adhesive tape according to another specific embodiment of the present disclosure;

FIG. 3 is a schematic structural diagram showing a guide rail platform, a heated component and a microwave heating head according to a specific embodiment of the present disclosure;

FIG. 4 is a schematic structural diagram of three different shapes of microwave heating heads according to a specific embodiment of the present disclosure;

FIG. 5 is a schematic structural diagram of a heated component according to a specific embodiment of the present disclosure.

In the drawings:
1—power supply; 2—microwave emitter; 3—microwave variable-frequency amplifier; 4—coupler; 5—power meter; 6—mechanical arm; 7—microwave heating head; 8—guide rail platform; 9—controller; 10—heated component; 11—positioning and mounting fixture; 12—pressure-sensitive adhesive tape and thermoplastic or thermosetting adhesive tape.

### DETAILED DESCRIPTION OF THE EMBODIMENTS

The present disclosure will be more completely understood by reading the following detailed description in conjunction with the accompanying drawings. Detailed embodiments of the present disclosure are disclosed herein. However, it should be understood that the disclosed embodiments are only exemplary of the present disclosure, which can be embodied in various forms. Therefore, specific functional details disclosed herein are not to be interpreted as limiting, but merely as a basis for the claims and as a representative basis for teaching those skilled in the art to variously employ the present disclosure in different ways in virtually any appropriate detailed embodiment.

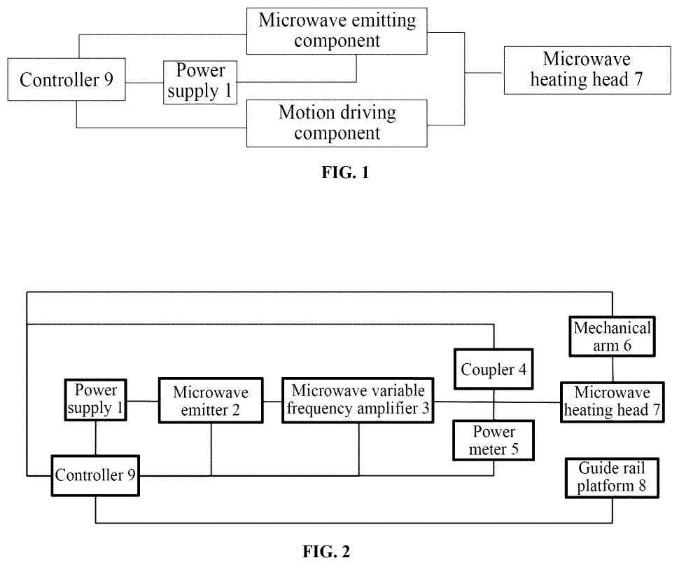

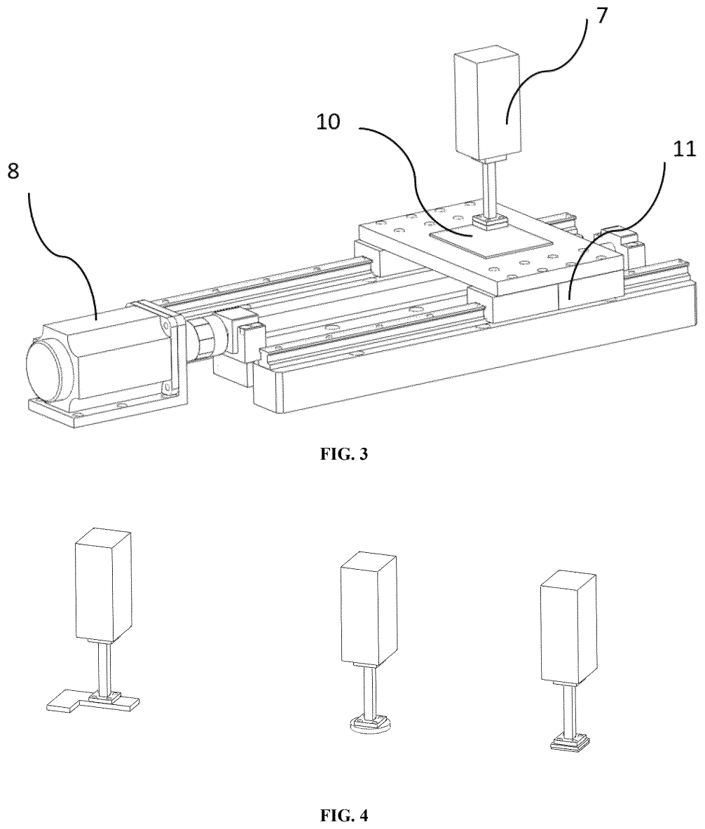

As shown in FIG. 1, a heating device for rapidly activating a pressure-sensitive adhesive tape and a thermoplastic or thermosetting adhesive tape is provided by an embodiment of the present disclosure. A heating object used by the device is a pressure-sensitive adhesive tape, and a thermoplastic or thermosetting adhesive tape 12. The device mainly includes a microwave heating head 7, a microwave emitting component, a motion driving component, a power supply 1, and a controller 9. Through the cooperation of the microwave emitting component and the motion driving component, the flexible heating of the thermosetting adhesive film according to the set motion trajectory is achieved by deploying microwaves with appropriate power.

In conjunction with FIG. 1 and FIG. 2, in this embodiment, the microwave emitting component is connected to the microwave heating head 7, and is used to transmit microwaves with proper power allocation to the microwave heating head 7, which specifically includes a microwave emitter 2, a microwave variable-frequency amplifier 3, a coupler 4, and a power meter 5. The microwave emitter 2 is used to generate microwaves with a certain power, which is a microwave emitting device, and may employ Samsung OM75P, Toshiba magnetron ER-2M248K (MM) series or ER-2M303J. The microwave variable-frequency amplifier 3 is connected to the microwave emitter 2, and is used to amplify the microwaves generated by the microwave emitter 2 to achieve a required heating frequency band. According to the frequency design and power requirements, a power amplifier ranging from 1 Hz to 18 GHz and with a power range of 100 W to 100 KW can be employed. The coupler 4 is connected to the microwave variable-frequency amplifier 3, and is used to allocate or screen the power of the microwave after variable-frequency amplification to achieve the required heating power, which may employ couplers C5315-102, IPP-2298, etc. The power meter 5 is connected to the microwave variable-frequency amplifier 3, and used for real-time power detection of the microwaves after variable-frequency amplification, which may employ Boonton4500B, ORITEL MH600, etc.

The motion driving component specifically includes a mechanical arm 6, and/or a guide rail platform 8. The mechanical arm 6 is connected to the microwave heating head 7, and used to drive the microwave heating head 7 to heat the heated component 10 according to a set motion trajectory. During implementation, a mechanical arm with a common structure in the automation industry can be employed. The guide rail platform 8 is connected to the heated component 10 and used to drive the heated component 10 to move. The guide rail platform 8 may be one of lead screw push type and slide rail type. Specifically, the guide rail platform 8 is provided with a positioning and mounting fixture 11, and the heated component is positioned and fixed onto the guide rail platform 8 by the positioning and mounting fixture 11. The mechanical arm 6 and the guide rail platform 8 are coupled to achieve accurate alignment and flexible movement of the microwave heating head 7 and the heated component 10. Meanwhile, the mechanical arm 6 can provide a press-fitting force of 0.05-0.5 MPa, thus achieving a pressing function.

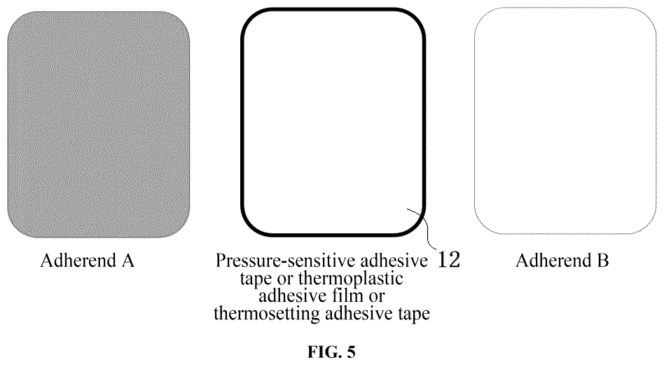

The microwave heating head 7 is connected to the microwave emitting component and the motion driving component, and is specifically connected to the microwave variable-frequency amplifier 3 of the microwave emitting component, and the guide rail platform 8 of the motion driving component. During implementation, the microwave heating head 7 may employ a patterned microwave heating head, which can be used to heat heated components with different structural shapes. The patterned microwave heating head 7 may be in the shape of hollow-square, square, circle, annular, L, or other shapes, and the pattern can be designed according to actual heating requirements, specifically as shown in FIG. 4. In addition, the microwave heating head 7 may also be provided with an optical coordinate sensor (not shown) and/or a temperature detection device (not shown). The optical coordinate sensor and the temperature detection device can be used for real-time monitoring and feedback of position coordinates of the microwave heating head 7 and the temperature of the heading head.

The power supply 1 is connected to the controller 9 and the microwave emitter 2 of the microwave emitting component, and used to supply power to the whole heating device to provide electrical power guarantee.

The controller 9 is connected to each of the power supply 1, the microwave emitting component and the motion driving component, at least includes a microwave emitter 2, a microwave variable-frequency amplifier 3, a coupler 4, a power meter 5, a mechanical arm 6, and a guide rail platform 8, and is used to achieve the setting and control of parameters of the whole heating device. The controller 9 may be selected from AL-20150 of MKS, SGP-30A of DAIHEN, etc.

During implementation, the heated component 10 specifically includes a pressure-sensitive adhesive tape, a thermoplastic or thermosetting adhesive tape, and adherends A and B (FIG. 5 for details).

The pressure-sensitive adhesive tape specifically includes an acrylic, rubber, polyurethane, silicone or hybrid single-sided pressure-sensitive adhesive tape, double-sided pressure-sensitive adhesive tape, or substrate-free pressure-sensitive adhesive tape.

The thermoplastic adhesive tape specifically includes an adhesive film prepared from a polar thermoplastic elastomer such as thermoplastic polyurethane, thermoplastic copolyester, thermoplastic polyimide, or EVA.

The thermosetting adhesive tape specifically includes an epoxy, polyurethane, acrylic or hybrid latent thermosetting single-sided adhesive tape, thermosetting double-sided adhesive tape, or thermosetting substrate-free adhesive tape.

The adherend generally includes stainless steel (SUS) or nickel-plated SUS, aluminum, glass, or ink glass, PC (polycarbonate), ABS (acrylonitrile butadiene styrene), etc.

During implementation, the bonding process of high-cohesion pressure-sensitive adhesive is that an adhesive tape is directly bonded to an adherend A by heating bonding equipment under the conditions of 40-60° C. and 0.1 MPa-0.5 MPa, and then the other adherend B is bonded and assembled to the adherend A by the heating bonding equipment under the conditions of 40-60° C. and 0.1 MPa-0.5 MPa, thus forming a bonded and activated component.

During implementation, the bonding process of the thermoplastic or thermosetting adhesive tape includes two steps: pre-bonding, and final bonding. The adhesive tape is pre-bonded on an adherend (the adherend is defined as a first adherend for the convenience of description) by the heating laminating equipment under the conditions of 40° C.-60° C. and 0.1 M Pa-0.3 MPa, and then the other adherend is pre-bonded and assembled to the first adherend by the heating laminating equipment under the conditions of 40° C.-60° C. and 0.1 MPa-0.3 MPa to form a heated pre-bonded component. In the final bonding, the heated component 10 is mounted on the positioning and mounting fixture of the motion driving component, and then motion trajectory calibration and temperature power correction are carried out. Specifically, the microwave heating head 7 is driven by the guide rail platform 8 and the mechanical arm 6 to perform motion trajectory calibration, and under the control of the controller 9, the output power and temperature of the microwave heating head 7 are corrected by the microwave emitting component under the controller 9 to achieve required set values. Finally, corresponding microwaves are sent by the microwave emitting component to the microwave heating head according to parameters related to variable-frequency microwaves set by the controller 9 (at least including a variable-frequency band, microwave output power, etc.), and the microwave heating head 7 is driven by the motion driving component to heat the heated component according to the set trajectory, thus forming a bonded and activated component.

According to a heating device for rapidly activating a pressure-sensitive adhesive tape and a thermoplastic or thermosetting adhesive tape provided by the embodiment of the present disclosure. The microwaves with proper power allocation are transmitted to the microwave heating head 7 by the microwave emitting component, and the microwave heating head 7 can achieve the flexible heating of the heated component fixed to a movable guide rail platform 8 according to the set trajectory. The flexible heating of various irregular pressure-sensitive adhesive tapes and thermoplastic or thermosetting adhesive tapes can be achieved by arranging the microwave heating head 7 to be structured in various patterns.

The specific application effects of the heating device for rapidly activating a pressure-sensitive adhesive tape and a thermoplastic or thermosetting adhesive tape provided by the embodiment of the present disclosure is shown in the following table:

| | | | Conventional hot-pressing | | This heating device | |
|---|---|---|---|---|---|---|
| | | | mode (Adherend: PC film/ | | (Adherend: PC film/ | |
| | Type of | Model of | Adhesive tape/PC board) | | Adhesive tape/PC board) | |
| Application | adhesive | adhesive | | 180° peeling | | 180° peeling |
| example | tape | tape | Parameter | force N/cm | Parameter | force N/cm |
| Application | High-cohesion | SG 8005H | 50° C., | 21 | 160 W, | 23 |
| example 1 | hard pressure- | | 0.1 MPa, | | 45° C., | |
| | sensitive | | 1 min | | 10 s | |
| | adhesive tape | | | | | |
| Application | Thermoplastic | SG | 110° C., | 36 | 160 W, | 38 |
| example 2 | polyurethane | TL0051WP | 0.1 MPa, | | 90° C., | |
| | adhesive tape | | 1 min | | 60 s | |
| Application | Thermosetting | SG | 100° C., | 77 | 160 W, | 74 |
| example 3 | polyurethane | LT0100B | 0.4 MPa, | | 70° C., | |
| | adhesive tape | | 1 min | | 60 s | |
| Application | | | 100° C., | 77 | 160 W, | 78 |
| example 4 | | | 0.4 MPa, | | 80° C., | |
| | | | 1 min | | 10 s | |

By comparing the application examples, it can be clearly explained that the heating device for rapidly activating a pressure-sensitive adhesive tape and a thermoplastic or thermosetting adhesive tape provided by the present disclosure can reduce the activation temperature while shortening the activation time.

Various aspects, embodiments, features and examples of the present disclosure should be considered as illustrative in all respects and are not intended to limit the present disclosure, and the scope of the present disclosure is defined only by the claims. Other embodiments, modifications and uses will be apparent to those skilled in the art without departing from the spirit and scope of the claimed present disclosure.

The use of titles and chapters in the present disclosure is not meant to limit the present disclosure. Each chapter can be applied to any aspect, embodiment, or feature of the present disclosure.

What is claimed is:

1. A heating device for activating a pressure-sensitive adhesive tape and a thermoplastic or thermosetting adhesive tape, wherein the pressure-sensitive adhesive tape comprises an acrylic, rubber, polyurethane, silicone or hybrid single-sided pressure-sensitive adhesive tape, double-sided pressure-sensitive adhesive tape, or substrate-free pressure-sensitive adhesive tape; the thermoplastic adhesive tape comprises an adhesive film prepared from a polar thermoplastic elastomer comprising thermoplastic polyurethane, thermoplastic copolyester, thermoplastic polyimide, or ethyl vinyl acetate (EVA); the thermosetting adhesive tape comprises an epoxy, polyurethane, acrylic or hybrid latent thermosetting single-sided adhesive tape, thermosetting double-sided adhesive tape, or thermosetting substrate-free adhesive tape;
the heating device comprises:
a microwave heating head;
a microwave emitting component, connected to the microwave heating head, and configured to output microwaves to the microwave heating head; and
a motion driving component, connected to the microwave heating head, and configured to achieve an alignment and a motion of the microwave heating head and a heated component;
wherein the microwave heating head is driven by the motion driving component to heat the heated component.

2. The heating device according to claim 1, wherein the microwave emitting component comprises a microwave emitter for generating the microwaves.

3. The heating device according to claim 2, wherein the microwave emitting component further comprises a microwave variable-frequency amplifier, wherein the microwave variable-frequency amplifier is connected to the microwave emitter and configured to perform variable-frequency amplification on the microwaves generated by the microwave emitter.

4. The heating device according to claim 3, wherein the microwave emitting component further comprises a coupler, wherein the coupler is connected to the microwave variable-frequency amplifier and configured for a power distribution or a screening of the microwaves after the variable-frequency amplification.

5. The heating device according to claim 4, wherein the microwave emitting component further comprises a power meter, wherein the power meter is connected to the microwave variable-frequency amplifier and configured for a real-time power detection of the microwaves after the variable-frequency amplification.

6. The heating device according to claim 1, wherein the motion driving component comprises a mechanical arm and/or a guide rail platform; the mechanical arm is connected to the microwave heating head and configured to drive the microwave heating head to heat the heated component according to a set motion trajectory; the mechanical arm is further configured to provide a press-fitting force of 0.05 MPa-0.5 MPa to achieve a pressing function; and the guide rail platform is connected to the heated component and configured to drive the heated component to move.

7. The heating device according to claim 6, wherein the heated component is positioned and fixed through a positioning mounting fixture arranged on the guide rail platform.

8. The heating device according to claim 1, wherein the microwave heating head is at least arranged to be hollow-square, square, circular, annular, or L-shaped.

9. The heating device according to claim 1, further comprising a controller, wherein the microwave emitting component and the motion driving component are connected to the controller.

10. The heating device according to claim 9, further comprising a power supply for supplying power to the heating device, wherein the power supply is connected to the controller and the microwave emitting component.
